(19) United States
(12) Patent Application Publication
(10) Pub. No.: US 2007/0150386 A1
(43) Pub. Date: Jun. 28, 2007

(54) Method for encouraging reporting of income/tips by sole proprietors and employees of cash based businesses

(76) Inventor: Alina Deibler, Scottsdale, AZ (US)

Correspondence Address: WEISS & MOY PC, 4204 NORTH BROWN AVENUE, SCOTTSDALE, AZ, 85251, US

(21) Appl. No.: 11/300,063

(22) Filed: Dec. 14, 2005

(51) Int. Cl. G06F 17/22

(52) U.S. Cl. 705/31

(57) ABSTRACT

A method for reporting income/tips by sole proprietor/employees of cash based businesses comprising: registering with the federal and local government as a cashed based business; reporting of gross income by the cash based business at designated time frames; and offering benefits by the federal and local government to the cash based business for accurate reporting of gross income received.

### FIELD OF THE INVENTION

This invention relates to tax reporting and, more specifically, to a method that encourages the reporting of income/tips by sole proprietors and employees of cash based businesses.

### BACKGROUND OF THE INVENTION

Presently, there are a multitude of occupations in which workers can earn up to $50,000 or more annually but pay very low taxes. These types of occupations are generally in “cash businesses”. Cash businesses are those in which only cash is accepted as payment or is generally accepted as payment for goods and/or services. Some examples of cash businesses include, but are not limited to: restaurants, bars, taxi services, cleaning and maintenance services, landscaping, construction/handyman, and the like.

In many cash businesses, there is a widespread practice of underreporting your tips or income. The IRS can use a “reasonable estimate” of tips received by employees to calculate a restaurant's share of FICA taxes, per the Supreme Court's 2002 decision on US vs. Fior D'Italia. The IRS's interest in unearthing these tax liabilities is clear. Billions of dollars in tips go unreported each year. The 7.65 percent employer tax (6.2% social security and 1.45% medicare withholding tax) on those billions is a large amount of money that the IRS is unable to collect.

Presently, cash businesses like restaurants allow waiters and other tipped employees to report gratuities monthly. But restaurants run the risk of having the IRS forcibly estimate waiters' cash tips based on the credit-card tipping rates. Waiters may feel compelled to report more tips, so that their own tax returns don't conflict with their employers'. Alternatively, restaurants can institute a more rigorous system of tip reporting, and perhaps enter into an agreement with the IRS that will reduce the likelihood the establishment will be audited.

Restaurants in some states have signed tip agreements with the IRS. These include, for example, eateries belonging to the Illinois and Nevada affiliates of the National Restaurant Association, a trade group in Washington, D.C. In Illinois, for example, the staff at the end of the night gets a printout of all their checks and the employees have to write in a tip for each printout. The IRS may question the restaurant if reported tips amount to only 5 percent or 10 percent of total receipts. So the restaurants, in turn, hold their waiters' feet to the fire and create a paper trail to back up the calculation of employer-side FICA tax. In Nevada, casinos have had tip rate determination agreements with the IRS for many years. In these agreements, the establishments accept IRS estimates of tips, and in exchange, the IRS says it won't audit the establishments or their workers.

While the above methods have help to encourage accurate tax reporting on tips and/or income form sole proprietors and employees of cash businesses, billions of dollars still go unreported each year. Presently, there is not a system in place that encourages sole proprietors and employees of cash businesses to accurately report their tips/income.

Therefore, a need existed to provide a method to overcome the above problem. The tax reporting method would encourage sole proprietors and employees of cash businesses to accurately report their tips/income.

### SUMMARY OF THE INVENTION

A method for reporting income/tips by sole proprietor/employees of cash based businesses is disclosed. The method comprises: registering with the federal and local government as a cashed based business; reporting of gross income by the cash based business at designated time frames; and offering benefits by the federal and local government to the cash based business for accurate reporting of gross income received.

A method for reporting income/tips by sole proprietor/employees of cash based businesses is disclosed. The method comprises: registering with the federal and local government as a cashed based business; registering with the federal and local government means for recording and monitoring cash flow received by the cash based business; reporting of gross income by the cash based business at designated time frames; accessing a penalty to the cashed based business if reporting of gross income by the cash based business is not done by the designated time frame; and offering benefits by the federal and local government to the cash based business for accurate reporting of gross income received, wherein the benefits is one of: medical coverage for the cash based business, free or reduced tuition at higher education institutions, free or reduced rent, and a guarantee of retirement income.

The present invention is best understood by reference to the following detailed description when read in conjunction with the accompanying drawings.

### BRIEF DESCRIPTION OF THE DRAWINGS

FIG. 1 is a flowchart depicting a method that encourages the reporting of income/tips by an individual cash based businesses.

FIG. 2 is a flowchart depicting a method that encourages the reporting of income/tips by employees of cash based businesses.

### DETAILED DESCRIPTION

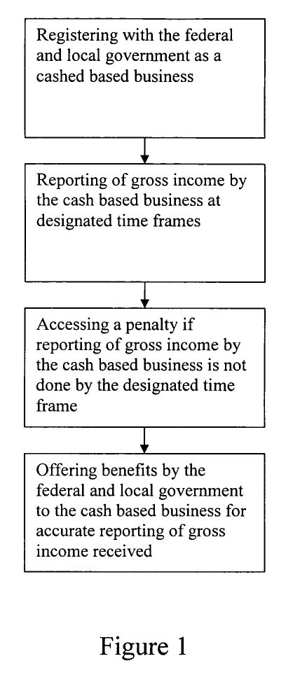

Referring to FIG. 1, a method that encourages the reporting of income/tips by employees of cash based businesses will be disclosed. The method disclosed in FIG. 1 relates to individual cash based businesses. The method would apply to individual cash based businesses such as a landscaper, handyman, a cleaning and maintenance individual, and the like. The listing is given as an example, and should not be seen as to limit the scope of the present invention.

All individual cash based businesses would have to register as a small business. This includes registering with the Internal Revenue Service (IRS), the state and the local city as a small business with a trademark name and an Employer Identification Number (EIN) (also known as a federal tax identification number and is used to identify the business entity) that allows the individual cash based businesses to do business in a specified location. Any individual cash based businesses that does not register and have an EIN or active registration will not be permitted to operate.

Once an individual cash based business is registered, the individual cash based business must report their gross income for the month to the IRS, state and local governments. The IRS or federal government will supply each registered individual cash based business with a uniform income statement form. Each month, or other designated time frame, the individual cash based business must fill in the income statement form and return it to the IRS by a designated time frame. For example, the income statement must be received by the 20^{th} of each month to report the gross income for the previous month. If the income statement form is not received by a designated time frame, the IRS may access a penalty or interest to the taxes that have to be paid. Current auditing methods may be used by the IRS to check for accuracy in the reporting of income by the registered individual cash based businesses. Alternatively, the IRS may require more detailed records to be submitted with each income statement in order to ensure accuracy in the reporting. A summary of the reported income, a gross income 1099MISC form may be sent out to the taxpayer by the IRS at the beginning of the year so that accuracy of the reported income may be verified.

In order to encourage reporting of gross income from the registered individual cash based business, the federal and local government will provide certain benefits to the registered individual cash based business. The benefits received must be sufficient enough so that the registered individual cash based business will want to report their gross income in order to receive the benefits. At the same time, the penalties or interest accessed needs to be stiff enough so that the registered individual cash based business will want to report their gross income instead of having to be accessed the penalty or interest.

The benefits provided may be set by the federal and local government. The benefits may be different for different registered individual cash based businesses. Each registered individual cash based business may be able to select which benefit they would like to receive. Alternatively, the federal and local government may only offer certain benefits to certain registered individual cash based businesses based on certain criteria.

One benefit the federal and local governments may provide is medical coverage for the individual cash based businesses. The medical coverage may be emergency medical coverage, basic medical coverage, or a more comprehensive medical package. The medical coverage may be based on different factors such as the amount of income from the individual cash based businesses, tax income generated from this program, and the like. he listing of the above is given as examples of different criteria and should not be seen as to limit the scope of the present invention. At a minimum, major medical coverage should be one of the benefits offered by the federal and local governments as an incentive for the accurate reporting of gross income from the registered individual cash based business. The medical coverage provided may work in conjunction with existing programs such as the federal based Medicare program or a local government program like ACCESS in the state of Arizona. The medical coverage would work in a similar manner to current plans where the individual cash based business would have to pay a co-pay for medical service and prescriptions. Again, these fees may be adjustable or on a sliding scale based on different characteristics of the individual cash based business. For example, co-pays could be based on a sliding scale based on national poverty guidelines. Also, doctors could be required to perform pro bono work in order to qualify them to keep there license (i.e., perform 20 hours of service to keep their license).

A second benefit offered by the federal and local governments may be free or reduced tuition at higher education institutions. The free or reduced tuition could be at public institutions or private institutions if the private institution is willing to participate in the tax program. The program may even include trade schools if the trade school is willing to participate in the tax program. The amount of reduction in tuition may be based on different factors such as the amount of income from the individual cash based businesses, tax income generated from this program, and the like. The listing of the above is given as examples of different criteria and should not be seen as to limit the scope of the present invention. The free or reduced tuition could work in conjunction with present government loan programs for schooling. The loans may be cancelled in whole or in part under the tax program.

A third benefit offered by the federal and local governments may be free or reduced rent.

The free or reduced rent could be at public housing or private housing if the private housing is willing to participate in the tax program. The amount of reduction in rent may be based on different factors such as the amount of income from the individual cash based businesses, tax income generated from this program, age of the person, and the like. The listing of the above is given as examples of different criteria and should not be seen as to limit the scope of the present invention.

A fourth benefit offered by the federal and local governments may be a guarantee of retirement income such as social security or the like. In accordance with one embodiment of the present invention, a certain amount of the tax paid by the individual cash based businesses may be set aside and placed in an interest bearing account to be paid to the individual cash based businesses upon retirement. This will ensure that the individual cash based businesses will receive social security benefits. Alternatively, the individual cash based business may be able to contribute more to a retirement fund like a 401K plan, 403B plan, Keogh plan, IRA, or the like. Other methods may be used to ensure that the individual cash based businesses will receive retirement income upon retirement without departing from the spirit and scope of the present invention.

The federal and local governments may offer one or more of the above benefits. If multiple benefits are offered, the individual cash based businesses may select which benefit it would like to receive. The above system will encourage individual cash based businesses to accurately report their tips/income since benefits received will be sufficient enough so that the registered individual cash based business will want to report their gross income in order to receive the benefits. Plus, at the same time, the penalties or interest accessed will to be stiff enough so that the registered individual cash based business will want to report their gross income instead of having to be accessed the penalty or interest.

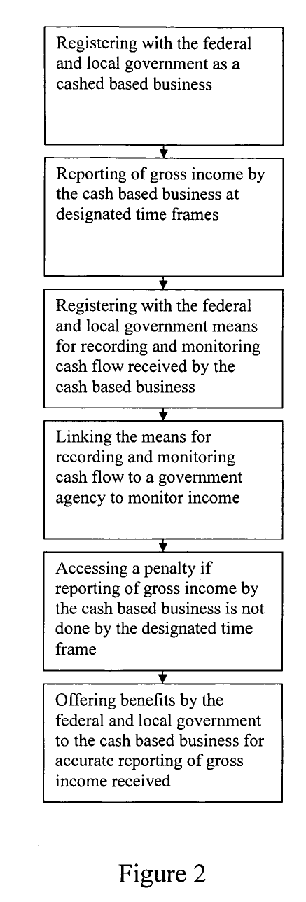

Referring to FIG. 2, a method that encourages the reporting of income/tips by employees of cash based businesses will be disclosed. The method disclosed in FIG. 2 relates to cash based businesses having multiple employees. The method would apply to cash based businesses such as a retail stores, bakeries, restaurants, taxi cab companies, and the like. The listing is given as an example, and should not be seen as to limit the scope of the present invention.

The method in FIG. 2 is basically the same as FIG. 1. The main difference is the way that the gross income will be monitored. Like the method of FIG. 1, the IRS or federal government may still supply the cash based business with a uniform income statement form. Each month, or other designated time frame, the cash based business must fill in the income statement form and return it to the IRS by a designated time frame. However, unlike registered individual cash based businesses which are more difficult to monitor, cash based businesses having multiple employees generally have means for recording and monitoring the cash flow received. For example, retail stores and bakeries generally have cash registers for conducting business. Taxi cabs have meter devices for monitoring the fare for each customer. Each means for recording and monitoring the cash flow received would be registered with the federal and local governments. The means for recording and monitoring the cash flow will be periodically checked by government officials to ensure that the devices have not been tampered.

Additionally, each means for recording and monitoring the cash flow may be linked to the IRS through wired or wireless means in order for the IRS to monitor income form these cash based businesses. The means for recording and monitoring the cash flow may be coupled to existing phone and cables lines or through wireless telecommunication means. The IRS can then monitor the cash flow from each cash based business. Income for individual employees can be based on the time worked and the gross income received by the cash based business. Alternatively or conjunction with the above, the IRS can estimate an employee's cash tips based on the credit-card tipping rates. If there is a discrepancy greater than a set percentage between the employees reported income and the IRS estimate, a more thorough audit may be performed.

In order to encourage reporting of gross income from the registered cash based business, the federal and local government will provide certain benefits to the registered cash based business similar to that described above. The benefits received will be sufficient enough so that the registered cash based business will want to report their gross income in order to receive the benefits. At the same time, the penalties or interest accessed needs to be stiff enough so that the registered individual cash based business will want to report their gross income instead of having to be accessed the penalty or interest. The benefits will include, but are not limited to: 1) medical coverage for the cash based business owner and employees; 2) free or reduced tuition at higher education institutions for the cash based business owner and employees; 3) free or reduced rent for the cash based business owner and employees; and 4) a guarantee of retirement income such as social security or the like for the cash based business owner and employees.

The federal and local governments may offer one or more of the above benefits. If multiple benefits are offered, the cash based business owner and employees may select which benefit they would like to receive. The above system will encourage cash based business owners and employees to accurately report their tips/income since benefits received will be sufficient enough so that the registered cash based business will want to report their gross income in order to receive the benefits. Plus, at the same time, the penalties or interest accessed will to be stiff enough so that the registered cash based business will want to report their gross income instead of having to be accessed the penalty or interest.

The above methods would benefit both the individual cash based business and the federal and state government. First, the deficit of the federal and local governments can be reduced since more taxable income is being reported. Second, taxes for the general population may be reduced since more taxable income is being reported. Third, the gross income of all Schedule C earners will become a reportable income. Furthermore, the process of applying for a loan, equity line of credit, or buying a house becomes easier. The lending institution would prequalify the individuals instantly. The income statements provided by the taxpayers (with the taxpayers permission) would be available and accessible within minutes by the taxpayer. This information would also be available to the court systems. This information could be used by judges in divorce, bankruptcy, and other legal proceedings.

This disclosure provides exemplary embodiments of the present invention. The scope of the present invention is not limited by these exemplary embodiments. Numerous variations, whether explicitly provided for by the specification or implied by the specification, such as variations in structure, dimension, type of material and manufacturing process may be implemented by one of skill in the art in view of this disclosure.

What is claimed is:

1. A method for reporting income/tips by sole proprietor/employees of cash based businesses comprising:
registering with the federal and local government as a cashed based business;
reporting of gross income by the cash based business at designated time frames; and
offering benefits by the federal and local government to the cash based business for accurate reporting of gross income received.

2. The method of claim 1 further comprising accessing a penalty to the cashed based business if reporting of gross income by the cash based business is not done by the designated time frame.

3. The method of claim 1 wherein registering with the federal and local government as a cashed based business further comprises obtaining a federal tax identification number.

4. The method of claim 1 further comprising registering with the federal and local government means for recording and monitoring cash flow received by the cash based business.

5. The method of claim 4 wherein registering with the federal and local government means for recording and monitoring cash flow received by the cash based business further comprises checking the means for recording and monitoring cash flow received periodically by government officials.

6. The method of claim 4 wherein registering with the federal and local government means for recording and monitoring cash flow received by the cash based business further comprises linking the means for recording and monitoring cash flow received by the cash based business to a government agency to monitor income form these cash based businesses.

7. The method of claim 6 wherein registering with the federal and local government means for recording and monitoring cash flow received by the cash based business further comprises linking the means for recording and monitoring cash flow received by the cash based business to a government agency to monitor income form these cash based businesses by one of a wired or wireless system.

8. The method of claim 1 wherein offering benefits to the cash based business for accurate reporting of gross income received by the federal and local government further comprises offering medical coverage for the cash based business by the federal and local government.

9. The method of claim 1 wherein offering benefits to the cash based business for accurate reporting of gross income received by the federal and local government further comprises offering one of free or reduced tuition at higher education institutions for the cash based business by the federal and local government.

10. The method of claim 1 wherein offering benefits to the cash based business for accurate reporting of gross income received by the federal and local government further comprises offering one of free or reduced rent for the cash based business by the federal and local government.

11. The method of claim 1 wherein offering benefits to the cash based business for accurate reporting of gross income received by the federal and local government further comprises offering a guarantee of retirement for the cash based business by the federal and local government.

12. A method for reporting income/tips by sole proprietor/employees of cash based businesses comprising:
registering with the federal and local government as a cashed based business;
reporting of gross income by the cash based business at designated time frames;
accessing a penalty to the cashed based business if reporting of gross income by the cash based business is not done by the designated time frame; and
offering benefits by the federal and local government to the cash based business for accurate reporting of gross income received, wherein the benefits is one of: medical coverage for the cash based business, free or reduced tuition at higher education institutions, free or reduced rent, and a guarantee of retirement income.

13. The method of claim 12 wherein registering with the federal and local government as a cashed based business further comprises obtaining a federal tax identification number.

14. The method of claim 12 further comprising registering with the federal and local government means for recording and monitoring cash flow received by the cash based business.

15. The method of claim 14 wherein registering with the federal and local government means for recording and monitoring cash flow received by the cash based business further comprises checking the means for recording and monitoring cash flow received periodically by government officials.

16. The method of claim 14 wherein registering with the federal and local government means for recording and monitoring cash flow received by the cash based business further comprises linking the means for recording and monitoring cash flow received by the cash based business to a government agency to monitor income form these cash based businesses.

17. The method of claim 16 wherein registering with the federal and local government means for recording and monitoring cash flow received by the cash based business further comprises linking the means for recording and monitoring cash flow received by the cash based business to a government agency to monitor income form these cash based businesses by one of a wired or wireless system.

18. A method for reporting income/tips by sole proprietor/employees of cash based businesses comprising:
registering with the federal and local government as a cashed based business;
registering with the federal and local government means for recording and monitoring cash flow received by the cash based business;
reporting of gross income by the cash based business at designated time frames;
accessing a penalty to the cashed based business if reporting of gross income by the cash based business is not done by the designated time frame; and
offering benefits by the federal and local government to the cash based business for accurate reporting of gross income received, wherein the benefits is one of: medical coverage for the cash based business, free or reduced tuition at higher education institutions, free or reduced rent, and a guarantee of retirement income.

19. The method of claim 18 wherein registering with the federal and local government means for recording and monitoring cash flow received by the cash based business further comprises checking the means for recording and monitoring cash flow received periodically by government officials.

20. The method of claim 18 wherein registering with the federal and local government means for recording and monitoring cash flow received by the cash based business further comprises linking the means for recording and monitoring cash flow received by the cash based business to a government agency to monitor income form these cash based businesses.
